(19) United States
(12) Patent Application Publication
(10) Pub. No.: US 2025/0019023 A1
(43) Pub. Date: Jan. 16, 2025

(54) AUXILIARY LIGHTING DEVICE FOR A TWO-WHEELER AND TWO-WHEELER WITH THE SAME

(71) Applicant: Jochen Klieber, Tacherting (DE)

(72) Inventor: Jochen Klieber, Tacherting (DE)

(21) Appl. No.: 18/715,386

(22) PCT Filed: Dec. 1, 2022
(86) PCT No.: PCT/EP2022/084080

§ 371 Date: May 31, 2024

(30) Foreign Application Priority Data
Dec. 2, 2021 (DE) 102021131816.5

(51) Int. Cl. B62J 6/03; B62K 23/06

(52) U.S. Cl. CPC B62J 6/03; B62K 23/06

(57) ABSTRACT

An additional lighting device for mounting on a two-wheeled vehicle in addition to a lighting device of the two-wheeled vehicle is designed such that it can be mounted on the two-wheeled vehicle by a mounting means in a specified position relative to the lighting device. The additional lighting device can be mounted in the specified position on the two-wheeled vehicle in such a way that the additional lighting device can illuminate an additional illumination area which is spatially specified relative to an illumination area of the lighting device. Also provided is use of a lighting device as additional lighting device on a two-wheeled vehicle in addition to a lighting device of the two-wheeled vehicle, and a two-wheeled vehicle with the additional lighting device.

### CROSS-REFERENCE TO RELATED APPLICATIONS

This application is the U.S. National Stage of PCT/EP2022/084080 filed on Dec. 1, 2022, which claims priority to German Patent Application 102021131816.5 filed on Dec. 2, 2021, the entire content of both are incorporated herein by reference in their entirety.

### FIELD OF THE INVENTION

The invention relates to an additional lighting device for mounting on a two-wheeled vehicle in addition to a lighting device of the two-wheeled vehicle, to the use of a lighting device as an additional lighting device on a two-wheeled vehicle in addition to a lighting device of the two-wheeled vehicle, and to a two-wheeled vehicle having an additional lighting device.

Lighting means are known that are attached to the front of two-wheeled vehicles and that illuminate a zone of the road located in front of the two-wheeled vehicle in the direction of travel. A zone of the road can in particular be illuminated thereby that is in front of the front wheel of the two-wheeled vehicle in the direction of travel.

### BACKGROUND OF THE INVENTION

In an aspect, the invention relates to an additional lighting device for mounting to a two-wheeled vehicle in addition to a lighting device of the two-wheeled vehicle. A two-wheeled vehicle can be a two-wheeled motorized or non-motorized vehicle. A two-wheeled vehicle can in particular be a bicycle, a motorcycle, or a motor scooter or foot-powered scooter. The additional lighting device and/or the lighting device can be a two-wheeled vehicle component releasably arranged at a two-wheeled vehicle or removable from a two-wheeled vehicle. The additional lighting device can be retrofitted to a two-wheeled vehicle frame or to a steering device of the two-wheeled vehicle. The additional lighting device can be mounted behind the lighting device at the two-wheeled vehicle in a direction of travel of the two-wheeled vehicle.

The lighting device can be any desired light source by means of which a specific zone can be irradiated by light. The lighting device can, for example, be a headlamp of a motorcycle or of a bicycle. The additional lighting device can be any kind of device for generating light that is suitable to irradiate a specific zone with light. The additional lighting device can be battery operated or can be supplied with energy in a different manner, for example by using the kinetic energy of the two-wheeled vehicle. The additional lighting device can have an individual light source such as a light bulb or also a plurality of light sources such as a cluster of light emitting diodes. The additional lighting device can, for example, be one or more light emitting diodes that are retrofitted as a light source for a bicycle. Alternatively or additionally, the additional lighting device can be provided with an optics such as at least one lens and/or at least one beam splitter to generate a predefined irradiation characteristic. The additional lighting device can, for example, generate a light field that is directed to a specific zone of the road surface by means of the optics and that illuminates the road surface with respect to a predefined geometry.

The additional lighting device is configured such that it can be mounted on the two-wheeled vehicle in a location predefined by the lighting device by means of a mounting means. A mounting means can be one or more arbitrary fastening elements to be able to establish a connection of the additional lighting device to the two-wheeled vehicle, for example a screw connection, a clamp connection, or a latch connection. The additional lighting device can be mounted on the two-wheeled vehicle in a position relative to a position of the lighting device predefined with respect to the two-wheeled vehicle or to the lighting device arranged on the two-wheeled vehicle. The additional lighting device can furthermore be mounted on the two-wheeled vehicle by means of the mounting means in an orientation relative to an orientation of the lighting device predefined with respect to the two-wheeled vehicle or to the lighting device arranged on the two-wheeled vehicle. The position and/or the orientation of the additional lighting device can define the location of the additional lighting device with respect to the lighting device.

The additional lighting device can be mounted on the two-wheeled vehicle in the predefined location by means of the mounting means such that an additional illumination zone can be illuminated by the additional lighting device. The additional illumination zone is spatially predefined with respect to an illumination hone of the lighting device. The additional illumination zone here designates that zone of a structure onto which the light generated by the additional lighting device is incident. The additional illumination zone can thus be that surface of a structure that is lit by the light of the additional lighting device. The additional lighting device can thus be an additional headlamp of the two-wheeled vehicle. The additional headlamp can in particular be retrofittably mounted on the two-wheeled vehicle. The additional illumination zone can in particular be a zone of a road irradiated by the additional headlamp, whereby the surface structure of the road is recognizable for a rider of the two-wheeled vehicle. Analogously to this, the illumination zone of the lighting device can likewise be the zone of a road irradiated by a headlamp of a two-wheeled vehicle, whereby the surface structure of the road is recognizable for a rider of the two-wheeled vehicle.

### SUMMARY OF THE INVENTION

The illumination zone can be arranged spatially in front of the additional illumination zone in the direction of travel of the two-wheeled vehicle. The direction of travel of the two-wheeled vehicle here designates the direction in which the two-wheeled vehicle moves when driving forward. The direction of travel can in particular correlate with a direction of gaze of the rider of the two-wheeled vehicle when moving forward. If the rider looks in this direction, he first sees the additional illumination zone and subsequently the illumination zone. Alternatively or additionally, the additional illumination zone can be arranged spatially next to the illumination zone in the direction of travel of the two-wheeled vehicle. The illumination zone and the additional illumination zone can at least partially overlap on one another.

A light cone can thus be generated by the lighting device that illuminates a surface section of the road when incident thereon. The illuminated zone of the surface section can form the illumination zone. Analogously to this, an additional light cone can be generated by the additional lighting device that illuminates an additional section of the surface of the road when incident thereon. The illuminated additional section of the surface can form the additional illumination zone. In accordance with the first aspect, the illumination zone can predefine a first partial zone of a surface section of the road of the two-wheeled vehicle to be illuminated. The additional illumination zone can predefine a second partial zone of the surface section of the road to be illuminated. The illumination zone and the additional illumination zone can, for example, be substantially circular. The road section to be illuminated can be predefined in the form of two circles arranged adjacent to one another in this case. The illumination zone and the additional illumination zone can additionally be substantially ellipsoid. The road section to be illuminated can be predefined in the form of two ellipses arranged adjacent to one another in this case. Alternatively, the illumination zone and the additional illumination zone can also be designed asymmetrically to one another to illuminate a road section to be illuminated asymmetrically, for example in the form of a droplet or of a cone.

In connection with the invention, an additional zone, for example a road surface, can thus be illuminated that is not illuminated with conventional lighting means for two-wheeled vehicles. Alternatively or additionally, a zone of the road surface can be illuminated by means of the additional lighting device in accordance with the invention that is expanded in comparison with a zone that can be illuminated by conventional lighting means for two-wheeled vehicles. The additional illumination zone can in particular be a zone directly below a front wheel of the two-wheeled vehicle. Bumps in the road, for example potholes or other obstacles, can hereby be better perceived by the rider of the two-wheeled vehicle. If in contrast only the conventional lighting device is used by which only a zone can be illuminated that is located in front of the two-wheeled vehicle in the direction of travel, such obstacles on the road can be easily overlooked by the rider. The proposed additional lighting device thus ensures an improved perception of the road by the rider of the two-wheeled vehicle and thus improves the ride safety of the two-wheeled vehicle. It is furthermore ensured by the spatial predefinition of the additional illumination zone relative to the illumination zone that no sight gaps arise between the two illumination zones that cannot be seen by the rider of the two-wheeled vehicle due to insufficient illumination. The ride safety of the two-wheeled vehicle is hereby further improved. Zones of the road surface or of the two-wheeled vehicle can furthermore be illuminated by means of the additional lighting device in accordance with the invention that are shaded or are not illuminated on an illumination with conventional lighting means.

In accordance with an embodiment, the additional lighting device comprises the mounting means. The mounting means is configured such that it can cooperate with a mounting device of the two-wheeled vehicle such that the additional lighting device can be mounted in the predefined location. The mounting device can be formed correspondingly with a fastening structure of the mounting means or can correspondingly cooperate with a fastening structure of the mounting means. The mounting means and the mounting device can cooperate mechanically, can for example implement a screw connection. Alternatively or additionally, the mounting means and the mounting device can cooperate by meshing with one another, can, for example, implement a latch connection. Alternatively or additionally, the mounting means and the mounting device can cooperate in a shape matched manner, can, for example, implement a clamp connection. The mounting means and the mounting device cooperate such that the additional lighting device is already in the predefined location due to the mounting. A subsequent change of the orientation and/or position of the additional lighting device can hereby be avoided.

In accordance with an embodiment, the mounting device is arranged at a frame component of the two-wheeled vehicle. The frame component can in particular be a down tube of a bicycle. The down tube is arranged between a drive device of the bicycle and a steering device of the vehicle. The additional lighting device can be arranged adjacent to the steering device at this down tube. Alternatively, the frame component can be a section of a motorcycle frame that likewise extends from a drive device of the motorcycle to a steering device of the motorcycle. The additional lighting device can likewise be arranged adjacent to the steering device of the motorcycle at this frame component. The arrangement of the additional lighting device on a frame component by means of the mounting device provides the advantage that sufficient space for the attachment and arrangement of the additional lighting device is present on the frame component. The additional lighting device is furthermore well protected on the frame component against damage that may arise, for example, by riding on a bumpy road.

In accordance with an embodiment, the mounting means is a component of a two-wheeled vehicle component releasably connectable to a frame component of the two-wheeled vehicle. The two-wheeled vehicle component can, for example, be a holder for beverages, a holder for a cell phone, or a mount for luggage that can in particular be retrofittably connected to the two-wheeled vehicle. The mounting means can be integrated in the two-wheeled vehicle component, that is, can be retrofittably connected thereto. Alternatively, the mounting means can already be integrated in the two-wheeled vehicle component on the manufacture thereof. The mounting means can be releasably connected to the two-wheeled vehicle as an element of the two-wheeled vehicle component. The mounting means can in particular be retrofittably connected to the two-wheeled vehicle to mount the additional lighting device as an element of the two-wheeled vehicle component.

In accordance with a further embodiment, the two-wheeled vehicle component has a stop element to bound an angle lock of handlebars of the two-wheeled vehicle. The stop element can be formed to take up a force acting on a steering device of the two-wheeled vehicle. The stop element can have a force reception region to take up a force that acts on the stop element on a pivoting of the steering device and on a contacting of the force reception region by the steering device. The stop element can furthermore have a support region connected to the force reception region to arrange the stop element at the down tube and to introduce the force acting on the stop element into the down tube. The stop element can have a cutout in which the mounting means is received. The stop element can in particular be retrofitted to the frame component together with the additional lighting device. The additional lighting device can thus be arranged on the two-wheeled vehicle in a simple manner as a part of the stop element.

In accordance with an embodiment, the mounting device is formed at a steering device of the two-wheeled vehicle. The mounting device can in particular be formed at a brake fitting of the two-wheeled vehicle arranged at a handlebar of the steering device. The handlebar can comprise a handlebar having handle pieces arranged at the respective ends of the handlebar. The brake fitting can comprise a brake lever and can be connected to the handlebar by means of a connection element. The mounting device can be arranged at a lower side of the connection element associated with the road surface. If the additional lighting device is connected to the mounting device by means of the mounting means, a road zone below the brake lever can accordingly be illuminated. The arrangement of the additional lighting device at a steering device of the two-wheeled vehicle furthermore provides the advantage that the additional lighting device is in the vicinity of the rider of the two-wheeled vehicle and its orientation can easily be changed by him.

In accordance with an embodiment, the illumination zone is spatially predefined such that a main beam axis of the additional lighting device is oriented in the direction of a road surface that can be ridden by the two-wheeled vehicle. A main beam axis of the additional lighting device can here be that axis along which a plurality of the light beams generated by the additional lighting device is propagated. In other words, the illuminance of the additional lighting device is the greatest along the main beam axis. The main beam axis can correspond to the normal on a light transmitting surface of the light source of the additional lighting device. If the additional lighting device has a plurality of light sources, the main beam axis can also be formed by an imaginary cylinder jacket within which the plurality of the main beam axes of the individual light sources extend. If the additional lighting device has an optics, the orientation and/or the shape of the main beam axis can be adapted by means of the optics.

In accordance with a further embodiment of the additional lighting device, the additional illumination zone is spatially predefined such that a main beam axis of the additional illumination zone is arranged substantially perpendicular to a direction of travel of a front wheel of the two-wheeled vehicle. What was explained in the above embodiment applies accordingly to the main beam axis. The direction of travel of the two-wheeled vehicle here designates the direction in which the two-wheeled vehicle moves when driving forward. The direction of travel can in particular correlate with a direction of gaze of the rider of the two-wheeled vehicle when moving forward. The additional illumination zone illuminated by the additional lighting device in this embodiment is accordingly located substantially perpendicular to the direction of gaze of the rider when driving forward and can thus be seen by the rider by inclining his head. The risk of a fall due to riding over an obstacle is hereby reduced.

It can be achieved by the substantially perpendicular orientation of the main beam axis of the additional lighting device relative to the direction of travel of the two-wheeled vehicle that the plurality of the light beams transmitted by the additional lighting device illuminate a road zone perpendicular to the direction of travel. The front wheel of the two-wheeled vehicle can in particular be located in this zone. This road zone can furthermore be easily seen by the rider, for example by a slight inclination of the head. The overview of the rider of the road zone to be ridden over and thus the ride safety of the two-wheeled vehicle is hereby further improved.

In accordance with a further embodiment of the additional lighting device, the additional illumination zone is spatially predefined such that a main beam axis of the additional lighting device extends in the direction of a contact surface of a front wheel of the two-wheeled vehicle. What was explained in the above embodiment applies accordingly to the main beam axis. The contact surface of the front wheel can here be that section of an outer surface of the front wheel that comes into contact with a surface of the road on a travel movement of the two-wheeled vehicle. The contact surface can in particular be a contact surface between an outer jacket of the front tire of the two-wheeled vehicle and the road surface. It is thus achieved in this embodiment that the illuminance is the greatest on a zone of the road surface directly below the front wheel of the two-wheeled vehicle. This zone hereby becomes better visible for the rider during riding, whereby the risk of a fall due to riding over an obstacle is reduced.

In the above-described embodiments, the main beam axis of the additional lighting device can differ up to an angle of a maximum of 30°, in particular a maximum of 20°, from the substantially perpendicular arrangement relative to the direction of travel of the two-wheeled vehicle and/or to the extent in the direction of a contact surface of the front wheel. This difference preferably amounts to a maximum of 10°. A change can be made continuously between the given angles, for example by means of a pivot joint for arrangement of the additional lighting device at the two-wheeled vehicle. Alternatively, the given angles can also be fixedly predefined, for example in steps of 10°, so that no selection of the angle difference is possible. Road zones can also be illuminated by the additional lighting device that are located in front of or behind the front wheel in the direction of travel due to the difference of the main beam axis from the perpendicular arrangement and/or the extent in the direction of the contact surface of the front wheel. The additional lighting device can hereby be adapted to different kinds of two-wheeled vehicles and/or different kinds of road surfaces.

In accordance with a further embodiment, the additional illumination zone is spatially predefined with respect to the illumination zone of the lighting device such that the illumination zone and the additional illumination zone contact one another. Two arbitrary sections of the outer margins of the illumination zone and of the additional illumination zone can hereby contact one another, for example. It can, for example, be a tangential contact of the respective outer peripheries of an illumination light cone and of an additional illumination light cone. The contact of the two illumination zones additionally prevents sight gaps arising between the two illumination zones that cannot be seen by the rider of the two-wheeled vehicle due to insufficient illumination. Reflection effects that can be caused by a double illumination of an overlapping zone of the two illumination zones are furthermore prevented. The recognizability of the road surface by the rider of the two-wheeled vehicle is hereby improved.

In accordance with a further embodiment, the additional illumination zone is spatially predefined with respect to the illumination zone of the lighting device such that the illumination zone and the additional illumination zone at least regionally overlap one another. In this embodiment of the additional lighting device, the illumination zone and the additional illumination zone can overlap in a region off a maximum of 33%, in particular a maximum of 25%, of the area of the additional illumination zone. The decisive area of the additional illumination zone is here the area projected onto the road surface and spanned by the light cone of the additional lighting device. An overlap of the illumination zone and of the additional illumination zone preferably takes place in a maximum of 10% of this area. It is made possible by this design that a specific zone of the road surface that is located directly in front of a contact surface of the front wheel in the direction of travel is illuminated both by the lighting device and by the additional lighting device. Obstacles located in the doubly illuminated zone are hereby particularly easily visible to the rider of the two-wheeled vehicle. The risk of a fall over these obstacles is reduced by this design of the additional lighting device.

In accordance with a further embodiment of the additional lighting device, the additional illumination zone spatially comprises the illumination zone. The surface of the road zone irradiated by the additional lighting device can thus be at least the same size as that of the road zone irradiated by the lighting device. The road zone irradiated by the lighting device can furthermore be contained in the road zone irradiated by the additional lighting device. The illumination zone and the additional illumination zone can be at least sectionally congruent. It can hereby be ensured that the illumination zone is also irradiated by the additional lighting device, that is, is illuminated twice.

In accordance with a further embodiment, the illumination zone and the additional illumination zone are illuminated in accordance with a predefined common geometrical arrangement. The illumination zone and the additional illumination zone can here respectively be illuminated, for example, in the form of a partial zone of a predefined geometrical figure such as a circle or an oval. If the illumination zone and the additional illumination zone are illuminated together, a zone in the form of the common geometrical figure can thus be illuminated. Alternatively, the illumination zone and the additional illumination zone can each be illuminated in the form of a geometrical figure such as of two ellipses. If the illumination zone and the additional illumination zone are illuminated together, a zone in the form of the two geometrical figures can thus be illuminated, for example of two ellipses. The shape of the geometrical figure illuminated by the additional lighting device can here differ from the shape of the geometrical figure illuminated by the lighting device. The additional illumination zone can, for example, be illuminated in the form of a triangle and the illumination zone can be illuminated in the form of a semicircle. In this respect, a common geometrical arrangement can be illuminated that is arranged in substantially droplet form. Alternatively or additionally, the additional illumination zone can be divided into a plurality of illumination sections, in particular divided in two. The individual sections of the additional illumination zone can each be illuminated identically or differently relative to one another. The additional illumination zone can, for example, be illuminated in the form of a plurality of ellipses formed identically with one another. Further designs and arrangements of the additional illumination zone and of the illumination zone are not precluded. The additional lighting device can accordingly be adapted to different kinds of two-wheeled vehicles and/or different road surfaces.

In a second aspect, the invention relates to the use of a lighting device as an additional lighting device on a two-wheeled vehicle in addition to a lighting device of the two-wheeled vehicle. The lighting device used is arranged on the two-wheeled vehicle in a location predefined with respect to the lighting device of the two-wheeled vehicle. The lighting device used is arranged at the two-wheeled vehicle such that an additional illumination zone can be illuminated by the lighting device used that is spatially predefined with respect to an illumination zone of the lighting device of the two-wheeled vehicle. The lighting device used can be formed like the additional lighting device described with respect to the preceding aspect.

In accordance with an embodiment, the lighting device used can be arranged at the two-wheeled vehicle such that the additional illumination zone can be illuminated in the form of at least one ellipse projected onto a road surface that can be ridden by the two-wheeled vehicle.

In a third aspect, the invention relates to a two-wheeled vehicle, in particular to a bicycle, having an additional lighting device in accordance with the first aspect.

In accordance with an embodiment, the additional lighting device comprises an environmental light sensor for the detection of an environmental brightness of the additional lighting device. The additional lighting device furthermore comprises a control device that is configured to control the former in dependence on the detected environmental brightness to illuminate the additional illumination zone based thereon. The environmental brightness can be defined, for example, with reference to a predefined threshold value. If, for example, the detected environmental brightness falls below the predefined threshold value, the control device can generate a signal to the latter to switch on a light source of the additional lighting device. Alternatively or additionally, the additional lighting device can also be configured to generate different brightness stages to illuminate the additional illumination zone. Depending on the detected environmental brightness, the control device can generate a signal to generate a certain brightness stage of the additional lighting device. This embodiment provides the advantage that the additional lighting device can be operated independently of a lighting device of the two-wheeled vehicle. The energy consumption of the additional lighting device can hereby be reduced.

In accordance with an embodiment, the additional lighting device comprises a motion sensor for the detection of a movement in the environment of the additional lighting device. The additional lighting device furthermore comprises a control device that is configured to control the former in dependence on the detected movement to illuminate the additional illumination zone based thereon. The movement can in particular be a rider approaching the two-wheeled vehicle. If, for example, the detected movement falls below a predefined threshold value, the control device can generate a signal to the latter to switch on a light source of the additional lighting device. Alternatively or additionally, the additional lighting device can also be configured to generate different brightness stages to illuminate the additional illumination zone in dependence on the detected movement. This embodiment provides the advantage that the additional lighting device can be operated independently of a lighting device of the two-wheeled vehicle. The energy consumption of the additional lighting device can hereby be reduced. Provision can be made that the additional lighting device comprises both an environmental light sensor and a motion sensor.

### BRIEF DESCRIPTION OF THE DRAWINGS

FIG. 1 schematically shows a two-wheeled vehicles with an additional lighting device in accordance with an embodiment of the invention;

FIG. 2 schematically shows a two-wheeled vehicle with an additional lighting device in accordance with a further embodiment of the invention;

FIGS. 3a-e show different spatial aspects of additional illumination zones with respect to predefined illumination zones;

FIG. 4a schematically shows a section of a steering device of a two-wheeled vehicle with an additional lighting device in accordance with a further embodiment of the invention;

FIG. 4b schematically shows the steering device of FIG. 4a in a frontal view in accordance with a further embodiment of the invention;

FIG. 5a schematically shows a frame component of a two-wheeled vehicle with an additional lighting device in accordance with a further embodiment of the invention;

FIG. 5b schematically shows a stop element arranged at the frame component of FIG. 5a with an additional lighting device in accordance with a further embodiment of the invention;

FIG. 6 schematically shows a two-wheeled vehicle with an additional lighting device in accordance with a further embodiment of the invention; and

FIG. 7 schematically shows a two-wheeled vehicle with an additional lighting device in accordance with a further embodiment of the invention;

### DETAILED DESCRIPTION OF THE INVENTION

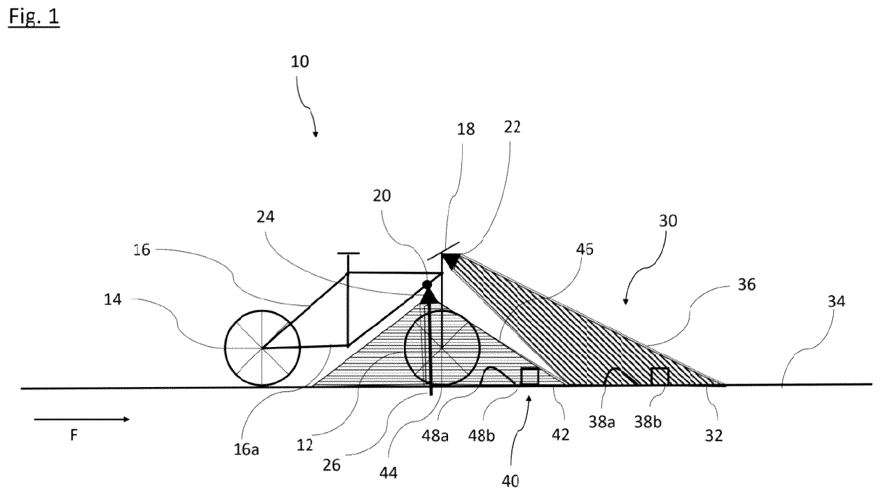

FIG. 1 shows a two-wheeled vehicle in the form of a bicycle 10. The two-wheeled vehicle 10 has a front wheel 12, a rear wheel 14, a frame 16, and a steering device 18. A lighting device 22 is arranged at the steering device 18. The lighting device 22 is configured as a front headlamp of the bicycle 10 in FIG. 1. The lighting device 22 is configured to illuminate an illumination zone 30. The illumination zone 30 is a surface section 32 of a road 34 that is illuminated by a light cone 36 generated by the lighting device 22. In other words, the surface section 32 of the road 34 is illuminated by the lighting device 22. Bumps 38a and/or obstacles 38b on the road 34 that are within the light cone 36 can hereby be better recognized by a rider of the two-wheeled vehicle 10.

In accordance with the embodiment of FIG. 1, an additional lighting device 24 is mounted on a frame component 16a of the frame 16 of the two-wheeled vehicle 10 by means of a mounting means 20. The additional lighting device 34 is configured as an additional headlamp of the two-wheeled vehicle 10 and can be subsequently attached to the frame component 16a of the frame 16 of the two-wheeled vehicle 10 by means of the mounting means 20. The additional lighting device 24 is attached to the frame component 16a of the frame 16 of the two-wheeled vehicle 10 such that the additional lighting device 24 illuminates an additional illumination zone 40. The additional illumination zone 40 is a further surface section 42 of the road 34 that is illuminated by a light cone 46 generated by the additional lighting device 24. In other words, the further surface section 42 of the road 34 is illuminated by the additional lighting device 24. The additional illumination zone 40 here also comprises a contact surface 44 of the front wheel 12, that is a section of the road 34 that is in contact with the front wheel 12. It is possible by means of the additional lighting device 24 to recognize bumps 48a and/or obstacles 48b within the illumination zone 40 that are located in front of the front wheel 12 on the road 34.

As can be seen from FIG. 1, the illumination zone 30 is arranged in front of the additional illumination zone 40 in the direction of travel F of the two-wheeled vehicle 10. When traveling in the direction of travel F, the illumination zone 30 is accordingly first illuminated by the lighting device 22. The additional illumination zone 40 is furthermore first illuminated by the additional lighting device 24. If the two-wheeled vehicle 10 continues to move forward in the direction of travel F, the illumination zone 30 is illuminated by the additional lighting device 24 at a later point in time. At this point in time, a further illumination zone located in front of the illumination zone 30 in the direction of travel F is already illuminated by the lighting device 22. The additional illumination zone 40 is thus spatially predefined with respect to the illumination zone 30 such that the surface section 32 of the road 34 is respectively illuminated in consecutive time periods once by the lighting device 22 and once by the additional lighting device 24. Bumps 38a, 48a and/or obstacles 38b 48b on the road can thus be better recognized.

As can be seen from the representation of FIG. 1, the illumination zone 30 and the additional illumination zone 40 contact one another. In other words, the light cone 36 of the illumination zone 30 and the additional light cone 46 of the additional illumination zone 40 contact one another along a contact section of their respective outer areas. The light cone 36 and the additional light cone 46 do not intersect, however.

The additional lighting device 24 has a main beam axis 26. The main beam axis 26 designates that direction in which a plurality of the light beams generated by the additional lighting device 24 propagate. The additional lighting device 34 thus has the greatest illuminance along the main beam axis 26. In the embodiment of FIG. 1, the main beam axis 26 of the additional lighting device 24 is oriented substantially perpendicular to the direction of travel F of the two-wheeled vehicle 10 in the direction of the road surface 34. If a rider of the two-wheeled vehicle 10 inclines his head when riding the two-wheeled vehicle 10, he likewise looks on the road 34 substantially perpendicular to the direction of travel F of the two-wheeled vehicle 10. The direction of gaze of the rider on an inclination of his head and the main beam axis 26 of the additional lighting device 24 accordingly overlap. The main beam axis 26 in the embodiment of FIG. 1 is furthermore oriented substantially perpendicular to the contact surface 44 of the front wheel 12. The illuminance of the additional lighting device 24 is hereby the greatest in the region of the contact surface 44 of the front wheel 12. The additional illumination zone 40, in particular its arrangement, is spatially predefined with respect to the illumination zone 30 by the orientation of the main beam axis 26 perpendicular to the direction of travel F or perpendicular to the contact surface 44 of the front wheel 12 in the direction of the road 34.

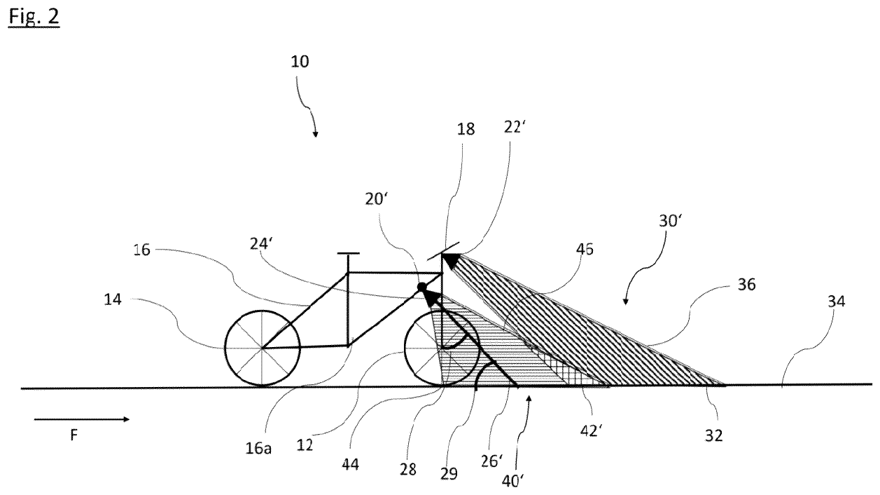

FIG. 2 shows a two-wheeled vehicle in the form of a bicycle 10 in accordance with a further embodiment. The two-wheeled vehicle 10 shown in FIG. 2 likewise has a lighting device 22′ and an additional lighting device 24′. Analogously to the representation of FIG. 1, the lighting device 22′ illuminates an illumination zone 30′. The additional lighting device 24′ illuminates an additional illumination zone 40′. The illumination zone 30′ is arranged in front of the additional illumination zone 40′ in the direction of travel F of the two-wheeled vehicle 10.

In the embodiment of FIG. 2, the additional lighting device 24′ is arranged at the frame component 16a of the frame 16 of the two-wheeled vehicle 10 such that the illumination zone 30′ and the additional illumination zone 40′ partially overlap in an overlap zone 42′ of the road 34. The area of the overlap zone 42′ here corresponds to a maximum of 33% of the area of the additional illumination zone 40′. Due to the partial overlap of the illumination zone 30′ and of the additional illumination zone 40′ in the overlap zone 42′, the overlap zone 42′ is illuminated both by the lighting device 22′ and by the additional lighting device 24′ during the travel of the two-wheeled vehicle 10. The overlap zone 42′ is accordingly doubly illuminated. A particularly relevant zone of the road 34, for example a zone directly in front of the front wheel 12 of the two-wheeled vehicle 10 can thus be illuminated with an increased illuminance due to the partial overlap of the illumination zone 30′ and of the additional illumination zone 40′.

In the embodiment of FIG. 2, the additional lighting device 24′ is arranged at the frame component 16a of the frame 16 of the two-wheeled vehicle 10 such that the main beam axis 26′ of the additional lighting device 24′ is inclined by an angle 28 relative to the direction of travel F of the two-wheeled vehicle 10. Furthermore, the additional lighting device 24′ is arranged at the frame component 16a of the frame 16 of the two-wheeled vehicle 10 such that the main beam axis 26′ of the additional lighting device 24′ is inclined by an angle 29 relative to the contact surface 44 of the front wheel 12 of the two-wheeled vehicle 10. Both the angle 28 and the angle 29 of the main beam axis 26′ amount to a maximum of 30°. The additional lighting device 24′ arranged at the angles 28, 29 likewise enables the double illumination of a particularly relevant zone, for example a zone directly in front of the front wheel 12 of the two-wheeled vehicle 10.

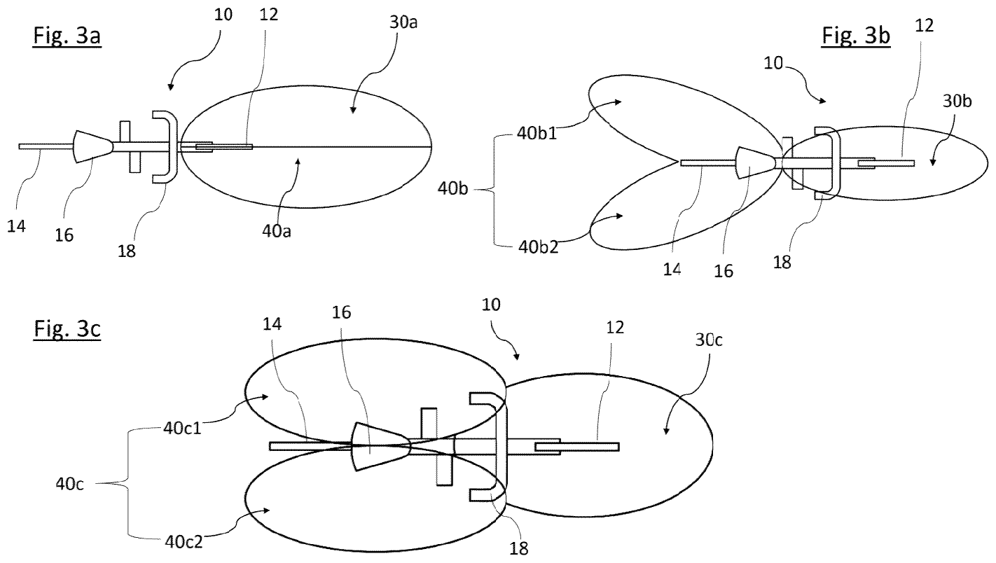

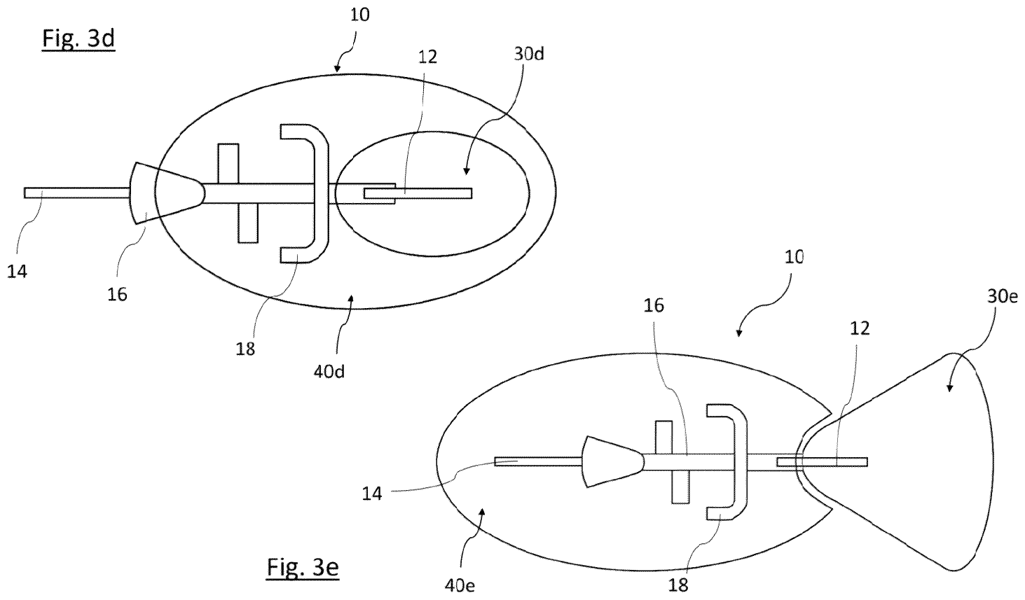

FIGS. 3a to 3e each show a plan view of a two-wheeled vehicle in the form of a bicycle 10 having different spatial embodiments of additional illumination zones with respect to predefined illumination zones. The bicycle 10 has a front wheel 12, a rear wheel 14, a frame 16, and a steering device 18. Each of the bicycles 10 shown in FIGS. 3a to 3e furthermore has a lighting device 22 that is not shown for reasons of clarity. The lighting device 22 is configured to illuminate a respective illumination zone 30a, 30b, 30c, 30d, and 30e. Each of the bicycles 10 shown in FIGS. 3a to 3e furthermore has an additional lighting device 24 that is likewise not shown for reasons of clarity. The additional lighting device 24 is configured to illuminate a respective additional illumination zone 40a, 40b, 40c, 40d, and 40e.

The lighting device 22 is designed in FIG. 3a such that it illuminates an illumination zone 30a in the form of a half-ellipse, for example by means of a beam splitter or reflectors. The additional lighting device 24 is designed in a comparable manner such that it illuminates an additional illumination zone 40a in the form of a half-ellipse. The additional illumination zone 40a is thus spatially predefined with respect to the illumination zone 30a such that the lighting device 22 and the additional lighting device 34 together illuminate an ellipsoid total illumination zone.

The illumination zone 30b of the representation of FIG. 3b is illuminated in the form of an ellipse in which the front wheel 12 of the bicycle 10 is located. In this representation, the additional lighting device is designed such that it on the one hand illuminates a first partial illumination zone 40b1 in the form of a first ellipse tilted relative to a longitudinal axis of the bicycle 10, for example by means of a beam splitter or reflectors. The additional lighting device 24 is furthermore designed in the representation of FIG. 3b such that it illuminates a second partial illumination zone 40b2 in the form of a second ellipse tilted relative to the longitudinal axis of the bicycle 10 and relative to the first partial illumination zone 40b1. The additional illumination zone 40b is accordingly divided into two in the representation of FIG. 3b and comprises the partial illumination zones 40b1 and 40b2. The rear wheel 14 of the bicycle 10 is illuminated by both partial illumination zones 40b1 and 40b2 In the embodiment of FIG. 3b. The illumination zone 30b and the additional illumination zone 40b admittedly contact one another at the margins, but do not overlap in the representation of FIG. 3b.

In the embodiment of FIG. 3c, the illumination zone 30c is again illuminated in the form of an ellipse in which the front wheel 12 of the bicycle 10 is located. The additional illumination zone 40c is again divided into two in the representation of FIG. 3c, similar to the representation of FIG. 3b, and comprises the partial illumination zones 40c1 and 40c2. The partial illumination zones 40c1 and 40c2 are illuminated, comparably with the representation in FIG. 3b, in the form of ellipses that, unlike the embodiment of FIG. 3c, are not tilted, but whose longitudinal axes are rather oriented in parallel with the longitudinal axis of the bicycle 10. The illumination zone 30c and the additional illumination zone 40c, or its partial illumination zones 40c1 and 40c2, furthermore overlap in the representation of FIG. 3c.

Equivalently to the embodiments of FIGS. 3a to 3c, the illumination zone in the embodiment of FIG. 3d is likewise illuminated in the form of an ellipse oriented along the longitudinal axis of the bicycle 12. The additional lighting device 24 is, however, configured in this embodiment such that it illuminates an additional illumination zone 40d that includes the illumination zone 30d. The illumination zone 30d is accordingly doubly illuminated in the representation of FIG. 3d.

In the embodiment of FIG. 3e, the illumination zone 30e is illuminated in the form of a truncated cone. The additional lighting device 24 is here mounted on the bicycle 10 in a predefined location by means of the mounting means 20 such that it illuminates an additional illumination zone 40e that is arranged behind the illumination zone 30d in the direction of travel. The illumination zone 30e and the additional illumination zone 40e are furthermore formed spatially separate from one another. The outer contour of the additional illumination zone 40e here sectionally follows the outer contour of the illumination zone 30e. The outer contour of the additional illumination zone 40e is here spaced apart from the outer contour of the illumination zone 30e.

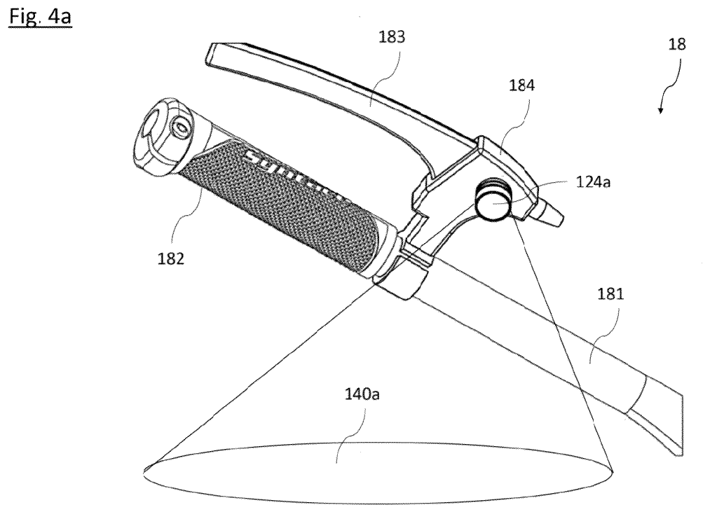

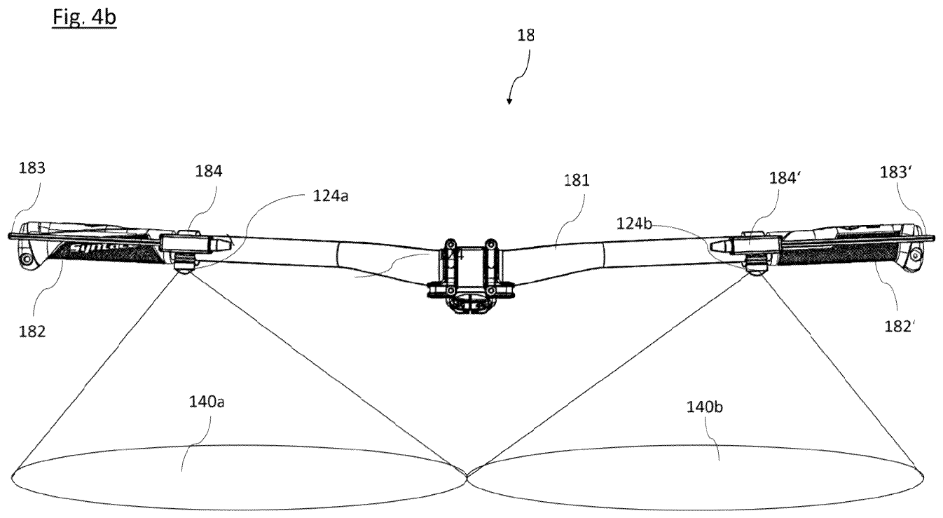

FIG. 4a shows a section of a steering device of a two-wheeled vehicle in the form of bicycle handlebars 18 in a view from below. The steering device 18 comprises a handlebar 181 and a handle piece 182 arranged at an end section of the handlebar 181. The handle piece 182 can be gripped in a known manner by a rider and can be used to steer the bicycle 10. The steering device 18 furthermore comprises a brake lever 183 that can be actuated in an known manner by the rider and that can be used to brake the bicycle 10. The brake lever 183 is held on the handlebar 181 by means of a mount 184.

An additional lighting device 124 in the form of a light emitting diode 124a is mounted on a lower side of the mount 184. For this purpose, the light emitting diode 124a comprises a mounting means that is configured in the form of an external thread 120 and that can cooperate with a mounting device configured in the form of an internal thread 121 to mount the light emitting diode 124a on the mount 184. As can be seen from FIG. 4a, the light emitting diode 124a is configured to illuminate an additional illumination zone 140a arranged below the light emitting diode 124a with respect to a direction of travel F of the two-wheeled vehicle.

FIG. 4b shows the bicycle handlebars 18 shown sectionally in FIG. 4a completely in a view from the front. In addition to the handle piece 182, the brake lever 183, and the mount 184, the steering device further comprises a further handle piece 182′, a further brake lever 183′, and a further mount 184′ that are likewise arranged on the handlebar 181. The further handle piece 182′, the further brake lever 183′, and the further mount 184′ are configured equivalently to the handle piece 182, the brake lever 183, and the mount 184.

A further light emitting diode 124b is mounted on a lower side of the further mount 184′. For this purpose, the light emitting diode 124b comprises a mounting means that is configured in the form of an external thread 120′ and that can cooperate with a mounting device configured in the form of an internal thread 121′ to mount the light emitting diode 124b on the mount 184′. As can be seen from FIG. 4b, the light emitting diode 124b is configured to illuminate an additional illumination zone 140a arranged below the light emitting diode 124b with respect to a direction of travel F of the two-wheeled vehicle. In the embodiment of FIG. 4b, the additional lighting device 134 is accordingly formed in two parts and comprises the light emitting diodes 124a, 124b. The two-part additional lighting device 124 is configured to illuminate the two-part additional illumination zone 140 that is formed by the partial illumination zones 140a and 140b.

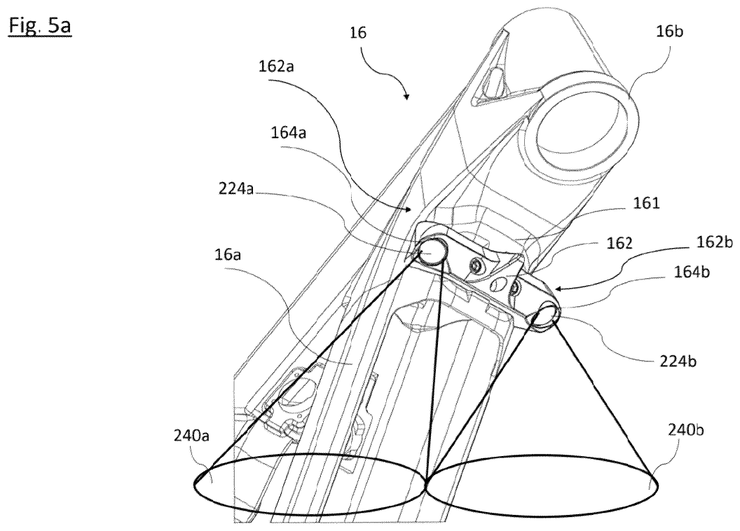

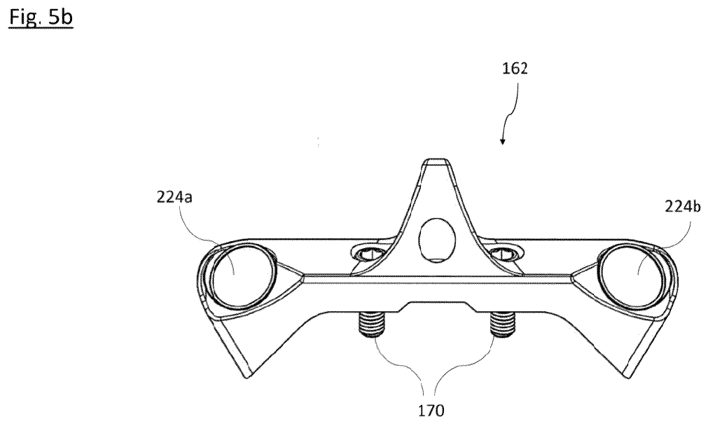

FIG. 5a shows a section of a frame 16 of a two-wheeled vehicle. The frame 16 comprises a down tube 16a and a control tube 16b. The down tube 18a has a recess 161. The recess 161 is configured to releasably receive a two-wheeled vehicle component shown as a stop element 162. The stop element 162 is configured to bound an angle lock of handlebars of the two-wheeled vehicle received in the control tube 16b and not shown in FIG. 5a.

The stop element 162 has two oppositely disposed end sections 162a, 162b along a longitudinal direction. A mounting means is arranged at the end section 162a of the stop element 162 that is shaped as a holder 164a and by means of which a light emitting diode 224a can be mounted on the down tube 16a as a part of an additional lighting device 224. Furthermore, a mounting means is arranged at the end section 162b of the stop element 162 that is shaped as a holder 164b and by means of which a further light emitting diode 224b can be mounted on the down tube 16a as a further part of the additional lighting device 224. The additional lighting device 224 is again configured in two parts in the embodiment of FIG. 5a and comprises the light emitting diodes 224a and 224b. The light emitting diodes 224a, 224b are configured to respectively illuminate a partial zone 240a, 240b of an additional illumination zone 240 arranged below the light emitting diodes 224a, 224b on a road 34 of the two-wheeled vehicle in the direction of travel F of the two-wheeled vehicle.

FIG. 5b shows the stop element 162 shown in FIG. 5a having the light emitting diodes 224a, 224b received therein and forming the additional lighting device 240 in a representation separated from the down tube 16a.

The stop element 162 can be fastened to the down tube 16a by means of screws 170. In other words, the stop element 162 can be retrofitted to the down tube 16a. Since the light emitting diodes 224a, 224b forming the additional lighting device 240 are received in the stop element 162, they can also be retrofitted to the down tube 16a as a member of the stop element 162.

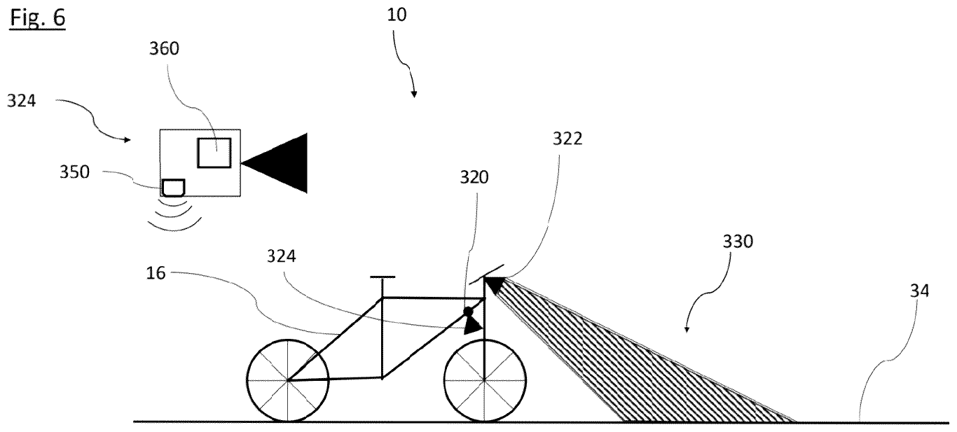

FIG. 6 shows a two-wheeled vehicle in the form of a bicycle 10 in accordance with an embodiment. The bicycle 10 comprises a lighting device 322 and an additional lighting device 324. The lighting device 322 is configured to illuminate an illumination zone 330 of the road 34. The additional lighting device 324 can be mounted on the bicycle 10 in a location predefined with respect to the lighting device 322 by means of a mounting means 320 and is configured to illuminate an additional illumination zone of the road 34 spatially predefined with respect to the illumination zone 330. In the representation of FIG. 6, the additional lighting device 324 is switched off, however.

The additional lighting device 324 is shown again in enlarged form in FIG. 6 and comprises an environmental light sensor 350 and a control device 360 that is in signal communication with the additional lighting device 324 and the environmental light sensor 350. The environmental light sensor 350 is here configured to detect an environmental brightness of the additional lighting device 324 and to transmit the detected environmental brightness to the control device 360. The control device 360 controls the additional lighting device 324 in dependence on the detected environmental brightness to illuminate the additional illumination zone. In the representation of FIG. 6, the additional lighting device 324 is switched off since the environmental brightness detected by the environmental light sensor 350 is sufficient to illuminate the road 34 with the aid of the lighting device 322.

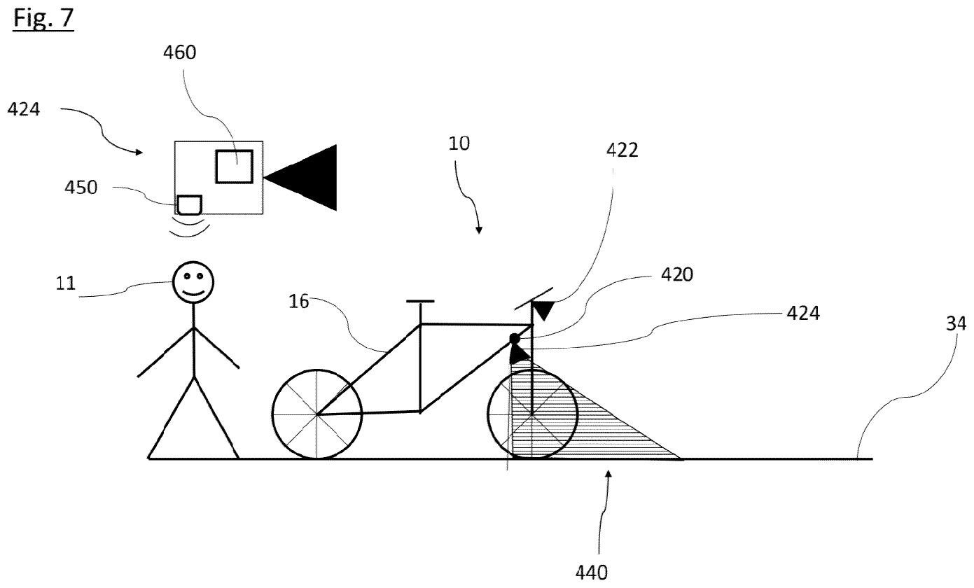

FIG. 7 shows a two-wheeled vehicle in the form of a bicycle 10 in accordance with a further embodiment. The bicycle comprises a lighting device 422 and an additional lighting device 424. The lighting device 422 is configured to illuminate an illumination zone 430 of the road 34. The additional lighting device 424 can be mounted on the bicycle 10 in a location predefined with respect to the lighting device 422 by means of a mounting means 420 and is configured to illuminate an additional illumination zone of the road 34 spatially predefined with respect to the illumination zone 430. In the representation of FIG. 7, the additional lighting device 422 is switched off, however.

The additional lighting device 424 is shown again in enlarged form in the representation of FIG. 7 and comprises a motion sensor 450 and a control device 460 that is in signal communication with the additional lighting device 424 and the motion sensor 450. The motion sensor 450 is here configured to detect a movement in the environment of the additional lighting device 424 and to transmit the detected movement to the control device 460. A movement in the environment of the additional lighting device 424 is shown in FIG. 7 by a rider 11 approaching the two-wheeled vehicle 10. The control device 460 controls the additional lighting device 424 in dependence on the detected movement to illuminate an additional illumination zone 440.

In the representation of FIG. 7, the additional lighting device 424 is switched on since the motion sensor 450 has detected the approaching rider 11. The control device 460 therefore controls the additional lighting device 424 to illuminate the additional illumination zone 440. Mounting the two-wheeled vehicle 10 is thereby facilitated for the rider 11.

The lighting arrangement in accordance with the invention for a two-wheeled vehicle was presented in FIGS. 1 to 7 with reference to a bicycle as an example of a two-wheeled vehicle. However, this is not to be understood as restrictive. The lighting arrangement can also be used with other kinds of two-wheeled vehicles such as motorcycles or scooters.

### REFERENCE NUMERALS

10 two-wheeled vehicle; bicycle
11 rider
12 front wheel
14 rear wheel
16 frame
16a frame component; down tube
16b control tube
161 recess
162 two-wheeled vehicle component; stop element
162a, 162b end sections of the stop element
18 steering device
181 handlebar
182, 182′ handle piece
183, 183′ brake lever
184, 184′ mount
20; 120, 120′; 164a, 164b mounting means
121, 121′ mounting device
22, 22′; 322; 422 lighting device
24; 24′; 124; 224; 324; 424 additional lighting device
124a, 124b; 224a, 224b light emitting diodes
26; 26′ main beam axis
28,29 angle of the main beam axis
30; 30′; 30a-30e; 330 illumination zone
32 surface section
34 road
30 light cone
38a, 38b bump, obstacle in the illumination zone
40; 40′; 40a-40e; 140; 240; 440 additional illumination zone
40b1-40c2; 140a-240b partial illumination zones
42 surface section
42′ overlap zone
44 contact surface of the front wheel
46 additional light cone
48a, 48b bump, obstacle in the additional illumination zone
350 environmental light sensor
450 motion sensor
360; 460 control device
F direction of travel

1. An additional lighting device for mounting on a two-wheeled vehicle in addition to a lighting device (22; 22′; 322;

422. of the two-wheeled vehicle, wherein:
the additional lighting device is configured such that it can be mounted on the two-wheeled vehicle in a location predefined with respect to the lighting device by a mounting means; and
the additional lighting device can be mounted on the two-wheeled vehicle in the predefined location by means of the mounting means such that an additional illumination zone can be illuminated by the additional lighting device and is spatially predefined with respect to an illumination zone of the lighting device.

2. The additional lighting device in accordance with claim 1, wherein:
the additional lighting device comprises the mounting means; and
the mounting means is configured such that it can cooperate with a mounting device of the two-wheeled vehicle such that the additional lighting device can be mounted in the predefined location.

3. The additional lighting device in accordance with claim 2,
wherein the mounting device is formed at a frame component of the two-wheeled vehicle, in particular at a frame component of the two-wheeled vehicle.

4. The additional lighting device in accordance with claim 2,
wherein the mounting means is formed as an element of a two-wheeled vehicle component releasably connectable to a frame component of the two-wheeled vehicle.

5. The additional lighting device in accordance with claim 4,
wherein the two-wheeled vehicle component has a stop element for bounding an angle lock of handlebars of the two-wheeled vehicle.

6. The additional lighting device in accordance with claim 2,
wherein the mounting device is formed at a steering device of the two-wheeled vehicle, in particular at a brake fitting of the two-wheeled vehicle arranged at handlebars of the steering device.

7. The additional lighting device in accordance with claim 1,
wherein the additional illumination zone is spatially predefined such that a main beam axis of the additional lighting device is oriented in the direction of a road surface that can be ridden by the two-wheeled vehicle.

8. The additional lighting device in accordance with claim 1,
wherein the additional illumination zone is spatially predefined such that a main beam axis of the additional lighting device is arranged substantially perpendicular to a direction of travel of the two-wheeled vehicle.

9. The additional lighting device in accordance with claim 1,
wherein the additional illumination zone is spatially predefined such that a main beam axis of the additional lighting device extends in the direction of a contact surface of the front wheel of the two-wheeled vehicle.

10. The additional lighting device in accordance with claim 8,
wherein the main beam axis differs up to an angle of a maximum of 30°, in particular of a maximum of 20°, from a substantially perpendicular arrangement with respect to the direction of travel and/or from an extent in the direction of the contact surface.

11. The additional lighting device in accordance with claim 1,
wherein the additional illumination zone is spatially predefined with respect to the illumination zone of the lighting device such that the illumination zone and the additional illumination zone contact one another.

12. The additional lighting device in accordance with claim 1,
wherein the additional illumination zone is spatially predefined with respect to the illumination zone of the lighting device such that the illumination zone and the additional illumination zone at least regionally overlap one another.

13. The additional lighting device in accordance with claim 12,
wherein the illumination zone and the additional illumination zone overlap in a region of a maximum of 33%, in particular a maximum of 25%, of the area of the additional illumination zone.

14. The additional lighting device in accordance with claim 1,
wherein the additional illumination zone spatially comprises the illumination zone.

15. The additional lighting device in accordance with claim 1,
wherein the illumination zone and the additional illumination zone are illuminated in accordance with a predefined common geometrical arrangement.

16. Use of a lighting device as an additional lighting device on a two-wheeled vehicle in addition to a lighting device of the two-wheeled vehicle, wherein:
the lighting device used is arranged on the two-wheeled vehicle in a location predefined with respect to the lighting device; and
the additional lighting device used is arranged on the two-wheeled vehicle such that an additional illumination zone can be illuminated by the lighting device used and is spatially predefined with respect to an illumination zone of the lighting device.

17. Use of a lighting device as an additional lighting device in accordance with claim 16,
wherein the lighting device used is arranged on the two-wheeled vehicle such that the additional illumination zone can be illuminated in the form of at least one ellipse projected onto a road surface that can be ridden by the two-wheeled vehicle.

18. A two-wheeled vehicle, in particular a bicycle, having an additional lighting device in accordance with claim 1.

19. The two-wheeled vehicle in accordance with claim 18, wherein:
the additional lighting device comprises an environmental light sensor for detection of an environmental brightness of the additional lighting device; and
the additional lighting device comprises a control device that is configured to control the additional lighting device in dependence on the detected environmental brightness to illuminate the additional illumination zone based thereon.

20. The two-wheeled vehicle in accordance with claim 18, wherein:
the additional lighting device comprises a motion sensor for detection of a movement in the environment of the additional lighting device; and
the additional lighting device comprises a control device that is configured to control the additional lighting device in dependence on the detected movement to illuminate the additional illumination zone based thereon.
